(19) United States
(12) Patent Application Publication
(10) Pub. No.: US 2002/0037150 A1
(43) Pub. Date: Mar. 28, 2002

(54) Duplication protecting system for recorded video media

(76) Inventors: Masahisa Hamada, Tokorozawa-shi (JP); Shohei Nakamura, Kitakatsushika-gun (JP)

Correspondence Address: LORUSSO & LOUD, 3137 Mount. Vernon Avenue, Alexandria, VA, 22305, US

(21) Appl. No.: 09/953,885

(22) Filed: Sep. 18, 2001

(30) Foreign Application Priority Data
Sep. 27, 2000 (JP) 2000-293575

(51) Int. Cl. H04N 5/76; G11B 15/04; G11B 19/04

(52) U.S. Cl. 386/1; 386/94; 380/213; 360/60

(57) ABSTRACT

During a period of a burst signal that controls a color in a video signal, a signal having the reverse phase and double the amplitude of the burst signal is added to superpose the signal on the burst signal by less than some cycles of the burst signal. A processed burst signal thus made is recorded on the magnetic tape. And, when reproducing the magnetic tape, a color signal detection circuit of a TV monitor is not influenced to reproduce a normal picture image. And, the color signal detection circuit of a video tape recorder is influenced to malfunction, which prevents a correct recording. To reproduce a magnetic tape duplicated by the video tape recorder by the TV monitor will present an abnormal picture image. Thus, the invention intends to prevent an unfair duplication, by making the color of the picture image abnormal in the unfair duplication.

### BACKGROUND OF THE INVENTION

1. Field of the Invention

The present invention relates to a system for protecting the contents of recorded video media from being duplicated, specifically to a system for protecting recorded video products from an unfair duplication, in which expensive full-length movie pictures or true record film pictures are recorded on CD-ROMs, DVDs, or high-picture-quality magnetic tapes.

2. Related Art

The present invention is a development of U.S. Pat. No. 4,475,129 (the Japanese Examined Patent Publication No. Hei 03-20957), which is intended to still more secure the claims thereof.

As disclosed in the “video technical guide” published by the Japan Victor Inc, September 1981, the magnetic tapes for video tape recorders contain species of the color burst signal (color sub-carrier: 3.58 MHz).

The video signal contains 8 through 10 cycles (wave number) of the 3.58 MHz color burst signal.

As shown in FIG. 8, in the video signal, 114 (one line of the horizontal scanning line) contains, starting with the horizontal synchronizing signal, the color burst signal and the image signal in this order, which is well known.

The color burst signal controls the color of picture images, and a normal recording and reproduction of the color burst signal permits reproduction of the same color as that of the original picture image.

In the conventional system, although it is well known that there exist unfair duplications of CD-ROMs, DVDs, or high-picture-quality magnetic tapes that contain expensive full-length movie pictures or true record film pictures, there is not an effective means developed for preventing that unfair duplication to a sufficient degree.

### SUMMARY OF THE INVENTION

It is therefore an object of the present invention to provide a system for protecting recorded video media from an unfair duplication, by paying attention to the recent image software generally having high-picture quality and high-definition color, and by making the color abnormal in case of an unfair duplication.

In order to accomplish the foregoing object, according to one aspect of the invention, in the system of recording a magnetic tape, dung a period of a burst signal that controls a color in a video signal, a signal having the reverse phase and double the amplitude of the burst signal is added by less than some cycles of the burst signal to superpose the signal on the burst signal, and a processed burst signal thus made is recorded on the magnetic tape. And, when reproducing the magnetic tape, a color signal detection circuit of a TV monitor is not influenced to reproduce a normal picture image, and the color signal detection circuit of a video tape recorder is influenced to malfunction, thus preventing a correct recording. Thereby, a reproduction of a magnetic tape duplicated by the video tape recorder by the TV monitor presents an abnormal picture image.

Further, in the system of recording a magnetic tape, the less than some cycles of the burst signal may be set to any one of half the cycle (half the wave), one cycle (one wave), 1.5 cycles (1.5 waves), 2 cycles (2 waves), 2.5 cycles (2.5 waves), 3 cycles (3 waves), 3.5 cycles (3.5 waves), 4 cycles (4 waves), 4.5 cycles (4.5 waves), and 5 cycles (5 waves).

Further, in the system of recording a magnetic tape, the starting position of the signal being added to the burst signal may be the same as the starting position of the burst signal.

According to another aspect of the invention, in the system of recording a magnetic tape, during a period of a burst signal that controls a color in a video signal, a command that adds a signal having the reverse phase and double the amplitude of the burst signal by less than some cycles of the burst signal to superpose on the burst signal is recorded together with the video signal on the record medium. And, when reproducing the record medium, a color signal detection circuit of a TV monitor is not influenced to reproduce a normal picture image, and the color signal detection circuit of a video tape recorder is influenced to malfunction, preventing a correct recording. Thereby, a reproduction of a magnetic tape created by the video tape recorder duplicating a picture image recorded on the record medium by the TV monitor presents an abnormal picture image.

According to another aspect of the invention, on the record medium, whose picture image is reproduced on a TV monitor, a command that adds, during a period of a burst signal that controls a color in a video signal, a signal having the reverse phase and double the amplitude of the burst signal by less than some cycles of the burst signal to superpose on the burst signal, is recorded together with the video signal.

Further, the record medium may be a compact disk that uses an optical/electronic system.

Further, the record medium may be a magneto-optical disk that uses an optical/magnetic/electronic system.

According to another aspect of the invention, the recording device to record a video signal reproduced on a TV monitor on a record medium, records, during a period of a burst signal that controls a color in the video signal, a command together with the video signal, that adds a signal having the reverse phase and double the amplitude of the burst signal by less than some cycles of the burst signal to superpose on the burst signal.

### BRIEF DESCRIPTION OF THE DRAWINGS

Preferred embodiments of the present invention will be described in detail based on the followings, wherein:

FIG. 1 illustrates waveforms to explain the generation of a quasi burst signal for a duplication protecting system for recorded video media relating to the invention;

FIG. 2 is a functional block diagram of the duplication protecting system for recorded video media of the embodiment 1 relating to the invention;

FIG. 3 is a functional block diagram, in which a video tape recorder duplicates a magnetic tape created by the duplication protecting system for recorded video media relating to the invention;

FIG. 4 is a functional block diagram of the duplication protecting system for recorded video media of the embodiment 2 relating to the invention;

FIG. 5 is a conceptual chart illustrating a state of the horizontal scanning line in one display for explaining the duplication protecting system for recorded video media relating to the invention;

FIG. 6 is another conceptual chart illustrating a state of the horizontal scanning line in one display for explaining the duplication protecting system for recorded video media relating to the invention;

FIG. 7 is another conceptual chart illustrating a state of the horizontal scanning line in one display for explaining the duplication protecting system for recorded video media relating to the invention; and

FIG. 8 illustrates a waveform of one frame of the horizontal scanning line for explaining the duplication protecting system for recorded video media relating to the invention.

### DETAILED DESCRIPTION OF THE PREFERRED EMBODIMENTS

A method of protecting a duplication of recorded video media and a device thereof will be described as one embodiment of the invention.

First, part of the background of the reproduction and duplication in the general video technique will be explained.

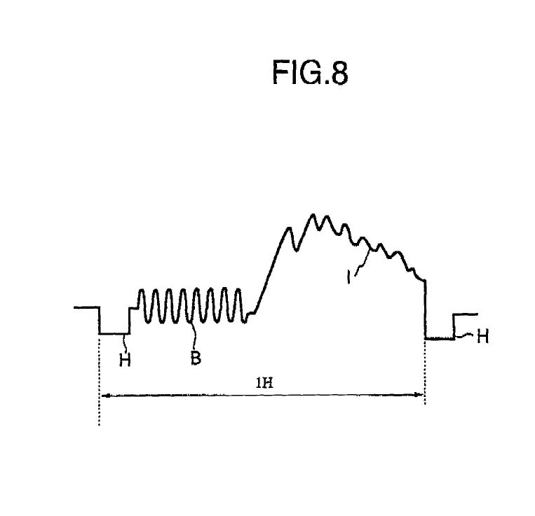

As shown in FIG. 8, 1 H (one line of the horizontal scanning line) in the video signal includes, starting with the horizontal synchronizing signal H, the color burst signal B and the image signal I.

In the NTSC system television, the one frame is composed of 525 horizontal scanning lines (hereunder, simply referred to as 525 H), and 30 screens are displayed for one second. Therefore, the one frame (525 H) takes 1/30 second, and 1 H 1(80×525) second.

Further, this 1 H each includes, within 1(30×525) second, the horizontal synchronizing signal for 5 μ sec, 8-10 cycles burst signal for about (8-10)/(3.6×1,000,000) second, and the video signal for about 0.8/(30×525) second.

### Embodiment 1

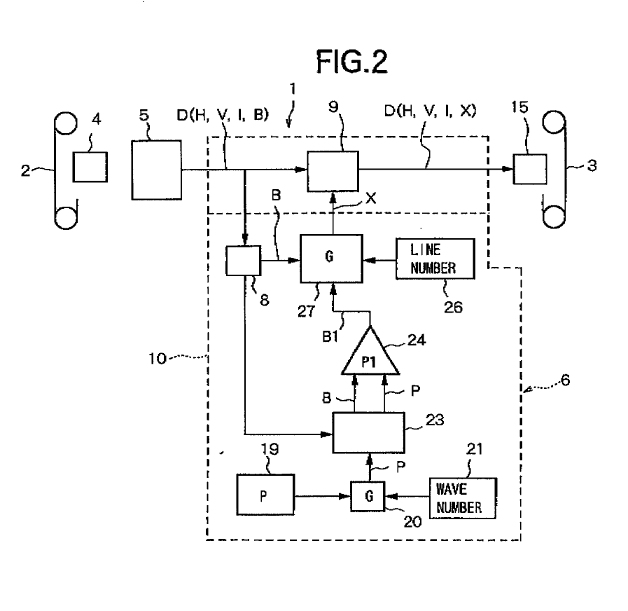

In FIG. 2, an original video tape 2 with a movie data recorded is loaded on a guard-adding device I to create an authorized magnetic tape 3 having a copy protection applied thereto.

The configuration of the guard-adding device 1 will be discussed with reference to FIG. 2.

The image signal is read from the original video tape 2 loaded on the guard-adding device 1 by a read head 4, based on the well known technique, and a video processing circuit 5 outputs to a processing circuit 6 a video signal D to which an amplification and other processing are applied.

The processing circuit 6 is to replace the burst signal E; in the video signal with a quasi burst signal B1, This processing circuit 6 is composed of a replacement circuit 9 and a processed burst signal generator 10.

The video processing circuit 5 supplies the replacement circuit 9 with the video signal D including each color signal, that is, the horizontal synchronizing signal H, the vertical synchronizing signal V, the burst signal B that controls the color, and the image signal I.

The replacement circuit 9 replaces the burst signal B with a processed burst signal X from the quasi burst signal generator 10, without giving any change to the horizontal synchronizing signal H, the vertical synchronizing signal V, and the image signal I in the video signal D. And, the replacement circuit 9 synthesizes these signals by the widely known timing technique, and outputs the result to a recording head 15.

The processed burst signal X is not made by changing the burst signal B for the whole scanning line in one display screen, but by replacing a part of the scanning line with the quasi burst signal B1 special for preventing a duplication.

Now, the processed burst signal generator 10 includes a burst signal extractor 8, a superposition signal generator 19, a wave number gate 20, a wave number controller 21, a phase adjuster 23, a superposing unit 24, a line number controller 26, and a line number gate 27.

The burst signal extractor 8 is supplied from the video processing circuit 5 with the video signal D including each color signal, that is, the horizontal synchronizing signal H, the vertical synchronizing signal V, the burst signal B that controls the color, and the image signal I.

The burst signal extractor 8 extracts only the burst signal B out of these signals supplied, and outputs the result.

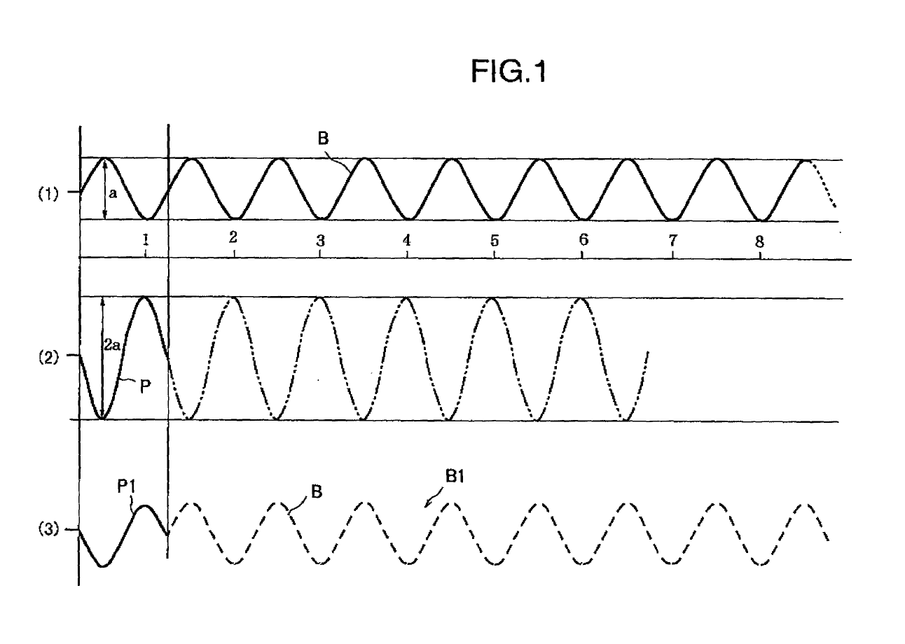

The frequency of the burst signal B (color sub-carrier) is 3.58 MHz, and the burst signal B is composed of 10 cycles (waves), for example, of the same waveform as shown in FIG. 1(1).

The burst signal extractor 8 sends out the burst signal B to the phase adjuster 23 and the line number gate 27 every specific cycle.

The superposition signal generator 19 generates a superposition signal P with a continuous waveform. The superposition signal P has double the amplitude of the burst signal B, and has a phase lead angle of 180° , which is in the reversed phase to the burst signal B, as shown in FIG. 1(2).

The wave number gate 20 restricts the cycle (wave) number of the superposition signal P, and sends the result to the phase adjuster 23.

The wave number controller 21 instructs the cycle (wave) number to pass the signal P to the wave number gate 20, and the pass numbers 1, 2, 3 . . . are variably set to the wave number controller 21.

The wave number gate 20 passes the superposition signal P to swing first to the negative direction by a specific cycle (wave) number that is instructed by the wave number controller 21.

The phase adjuster 23 adjusts the phase so as to bring the position of the burst signal B starting to swing to the positive direction in coincidence with the position of the superposition signal P starting to swing to the negative direction.

The line number controller 26 instructs the horizontal scanning line (X) number to be selected to the line number gate 27, and the selection numbers 1, 2, 3 . . . are variably set to the line number controller 26 The line number gate 27 simultaneously inputs the burst signal B and the quasi burst signal B1, and outputs these signals alternatively each by a specific line number.

The line number gate 27 not only selects these signals simply alternatively but alternatively outputs these signals, according to the values of the line numbers among 525 H in one display (frame), that the line number controller 26 has set to the burst signal B and the quasi burst signal B1.

The generation of the quasi burst signal B1 will further be described in detail.

The burst signal extractor 8 outputs the burst signal B composed of, for example, 8 cycles (about 10 waves) as shown in FIG. 1(1).

The superposition signal generator 19 generates the superposition signal P, as shown in FIG. 1(2), that has a double amplitude 2a against the amplitude a of the burst signal B. The wave number gate 20 outputs the superposition signal P that first swings to the negative direction, which is composed of; for example, one cycle (wave) set by the wave number controller 21.

The burst signal B and the superposition signal P are sent to the phase adjuster 23, if there is a phase discrepancy for starting to swing, the phase will be adjusted and sent to the superposing unit 24.

The superposing unit 24 adds the first one cycle (one wave) of the burst signal B and the first one cycle (one wave) of the superposition signal P to superpose each other, which creates the quasi burst signal B 1 composed of a deformed superposition signal P1 for one cycle (one wave) and the burst signal B for the remaining 9 cycles as shown in FIG. 1(3).

The quasi burst signal B1 is such that the deformed superposition signal P1 having the amplitude virtually a and the phase shifted by 180° (reverse phase) to the burst signal B for one waveform is set to the first one cycle of the burst signal B.

According to the set value by the line number controller 26, the line number gate 27 replaces the burst signal B in one display with the quasi burst signal B1 in a unit of the scanning line number, and sends out the processed burst signal X whose mixing ratio is 12 H to 1 H, for example, to the replacement circuit 9.

The replacement circuit 9 passes the image signal I and the horizontal synchronizing signal H and the vertical synchronizing signal V from the video processing circuit 5 as they are, replaces the proper burst signal B with the processed burst signal X, and outputs the result to the recording head 15.

The recording head 15 writes the processed burst signal X together with the image signal I and the horizontal synchronizing signal H, and the vertical synchronizing signal V onto the magnetic tape 3.

The processed burst signal X is made such that the burst signal B of some lines among 525 H in one display (frame) is replaced with the quasi burst signal B1 (for example, one line for every 12 lines).

The magnetic tape created by the guard-adding device 1 will be the authorized magnetic tape 3 with duplication protection.

A rightful person (corporation) mass produces the authorized magnetic tape 3 by the guard-adding device 1, and sells them through the video market.

The processed burst signal X is able to produce various types, according to the set values by the line number controller 26. For example, among 525 H in one display (frame), 20 H is assigned to the burst signal B, next 1, or 2, or 3, . . . H is assigned to the quasi burst signal B1, and next 20 H is assigned to the burst signal B, and then next 1, or 2, or 3, . . . H is assigned to the quasi burst signal B1; such a repetitive setting can be made.

Further, the processed burst signal X may be made such that in more than 525 H, namely; every plural displays, some lines of the burst signal B are repetitively replaced with the quasi burst signal B1.

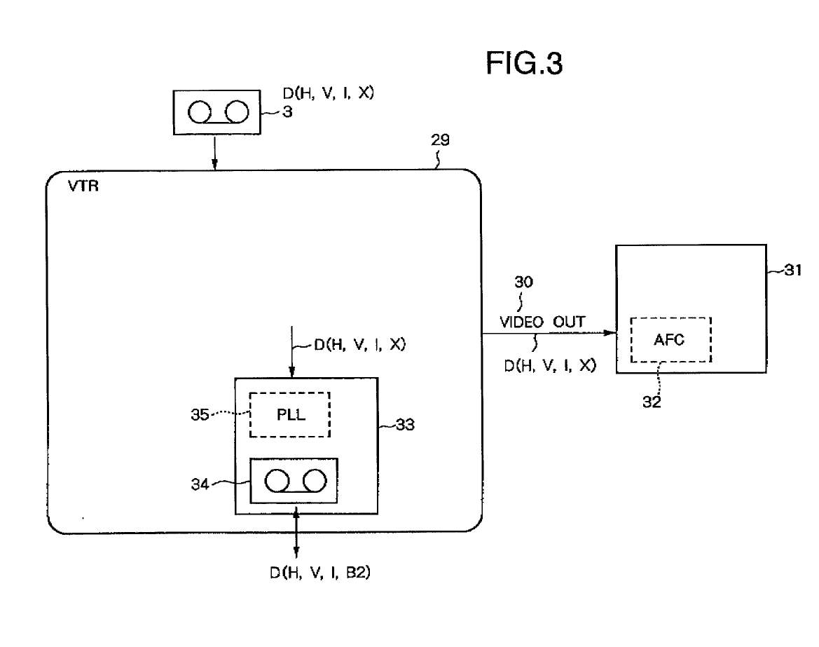

A case of reproducing the authorized magnetic tape 8 by a video reproduction device 29 and presenting the contents on a TV monitor 31 will be explained with reference to FIG. 3.

The authorized magnetic tape 3 contains a film drama and the like, together with the processed burst signal X.

The video signal is read out through the read head from the authorized magnetic tape 3, based on the known method, and the video signal D is amplified and compensated by the video processing circuit; and it is decomposed into the image signal I and the horizontal synchronizing signal H and the vertical synchronizing signal V, and the processed burst signal X (mixture of the quasi burst signal B1 and the burst signal B), which are outputted from a video output terminal 30.

The video output terminal 30 supplies the image signal I and the horizontal synchronizing signal H, and the vertical synchronizing signal V of the video signal D, and the processed burst signal X to the general TV monitor 31.

The TV monitor 31 is provided with an AFC (automatic frequency control) circuit 32, and the AFC circuit 32 has a function to reproduce, based on the major component burst signal B having more waves, the deformed superposition signal P1 (pat of the quasi burst signal B1) having less waves forcibly into the burst signal B. That is, the AFC circuit 32 restores the burst signal B shown in FIG. 1(1) from the quasi burst signal B1 shown in FIG. 1(2).

Accordingly, as the authorized magnetic tape 3 containing the quasi burst signal B1 is reproduced on the TV monitor 31, the color signal detection circuit of the TV monitor 31 is free from influence, because the quasi burst signal B1 is replaced by the normal burst signal B.

Since the color controller driven by the normal burst signal B is not influenced at all, a normal color film picture can be reproduced.

Now, the inventor has discovered experimentally that the AVC circuit 32 loses the ability to generate the normal burst signal B when the wave number of the deformed superposition signal P1 set by the wave number controller 21, of the quasi burst signal B1 shown in FIG. 1(3), increases to more than 6 cycles (6 waves).

Further, the inventor has found experimentally that the AFC circuit 32 loses the function when the line number of the quasi burst signal B1 set by the line number controller 26, following the burst signal B of, for example, continuous 12 H of 525 H in one display (frame) becomes more than 10 (even if the deformed superposition signal P1 is one cycle).

Therefore, the contents and types of the processed burst signal X (mixture of the quasi burst signal B1 and the burst signal B) should be determined in view of such restrictions.

A case of duplicating the authorized magnetic tape 3 by a video tape recorder VTR 29 (including the video reproduction device 29, at present) will be explained with reference to FIG. 3.

The video signal is read out through the read head from the authorized magnetic tape 3, and the video signal D is amplified and compensated by the video processing circuit; and it is decomposed into the image signal I and the horizontal synchronizing signal H and the vertical synchronizing signal V; and the processed burst signal X (mixture of the quasi burst signal B1 and the burst signal B), which are outputted to a record system circuit 33 through the internal wing.

While a duplication magnetic tape 34 is loaded on the video tape recorder VTR 29, the record system circuit 33 is furnished with a lock circuit (PLL) 35.

Receiving the processed burst signal X (B1+B), the PLL circuit 35 generates an increased quasi burst signal B2 having the wave number of the deformed superposition signal P1 changed into more than several cycles (6 waves, for example), in spite of the wave number of the deformed superposition signal P1 inside the quasi burst signal B1 shown in FIG. 1(3) being one eyle (one wave).

The lock circuit (PLL) 35 is locked by the deformed superposition signal P1 (one wave in the reverse phase) having the phase difference by 180° to the proper burst signal B, and returns to the normal burst signal B after several waves. However, it will not restore the normal operation for the burst period of 8 waves to 10 waves.

Therefore, on the duplication magnetic tape 34 is recorded the increased quasi burst signal B2 that contains about 6 cycles (6 waves) of the deformed superposition signal P1 as part of the video signal.

Here, the duplication magnetic tape 34 is loaded on the video tape recorder 29 in FIG. 3, in replacement of the authorized magnetic tape 3, and is reproduced on the TV monitor 31.

Since the wave number of the deformed superposition signal P1 of the increased quasi burst signal B2 is increased to more than several cycles (6 waves), the automatic frequency control function of the AFC circuit 32 becomes disordered, and the function to restore the burst signal B will be lost.

The color signal detection circuit of the TV monitor 31 that receives the video signal with the deformed superposition signal P1 increased to several cycles (6 waves) receives influence to reproduce a picture image having a color abnormally changed.

The reproduced picture image presents the “moire” phenomenon only on the color, or slightly abnormal fluctuations, but the picture image itself is not disturbed. However, as a product, it is defective.

To market such duplication magnetic tapes 34 will clearly give rise to consumers' objections and complaints, which will be a big brake to producing such duplication magnetic tapes 34 as a business, consequently leading to a success of the copy prevention.

### Embodiment 2

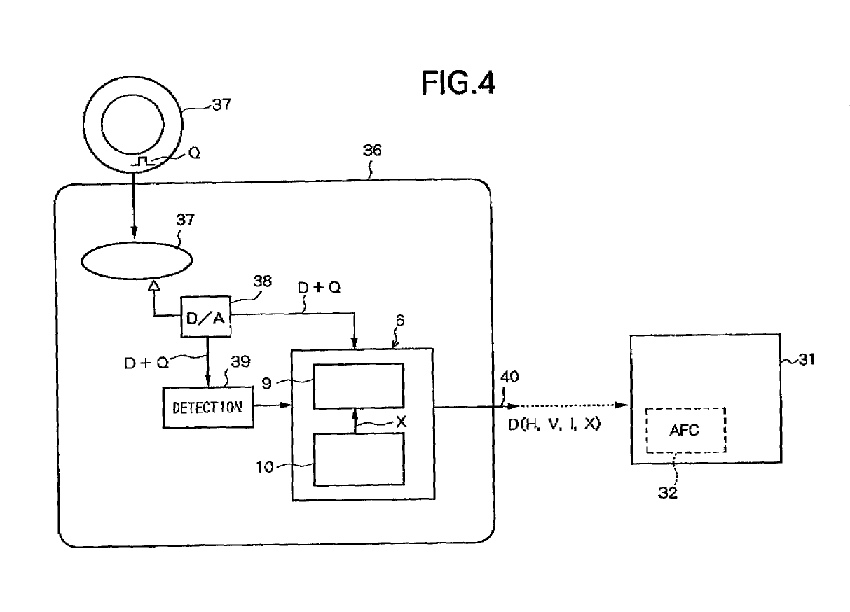

FIG. 4 illustrates a case of a CD-ROM 37 as a record medium and a DVD reproduction device 36.

When picture films are recorded on a CD-R, a copy guard signal Q is simultaneously recorded together with the video signal (picture film data) D by the known method. The CD-ROM that contains these signals D and Q will be the authorized CD-ROM 37 with duplication prevention.

On the other hand, the DVD reproduction device 36 is furnished with a signal converter 38, a detection 39 that detects the copy guard signal Q, and the processing circuit 6 including the replacement circuit 9 and the quasi burst signal generator 10.

A case of reproducing the authorized CD-ROM 37 by the TV monitor 31 will be explained with reference to FIG. 4.

A CD driver reads the authorized CD-ROM 37, where the CD driver irradiates laser beams on long and short pits physically made on the authorized CD-ROM 37 that rotates.

The signal converter 38 converts the light video signal contained in the laser beams reflected from the authorized CD-ROM 37 into an electrical video signal D.

The video signal D is composed of the picture film data being the proper video signal D and the copy guard signal Q.

The detection 39 detects the copy guard signal Q, and starts the replacement circuit 9 and the quasi burst signal generator 10 of the processing circuit 6.

The replacement circuit 9 of the processing circuit 6 is supplied with the copy guard signal Q, and the video signal D including each color signal, namely, the horizontal synchronizing signal H, the vertical synchronizing signal V, the burst signal B that controls the color, and the image signal I.

The quasi burst signal generator 10 sends out the processed burst signal X to the replacement circuit 9, in the same manner as in the embodiment 1.

The replacement circuit 9, ignoring the copy guard signal Q, replaces the proper burst signal B by the processed burst signal X, in the same manner as in the embodiment 1, and outputs the result to the outside through the video output terminal 40.

The TV monitor 31 processes the video signal D thereafter, in the same manner as in the embodiment 1.

When receiving the video signal D reproduced from the authorized CD-ROM 37, the color signal detection circuit of the TV monitor 31 is not influenced, and the TV monitor 31 reproduces a normal color picture, in the same manner as in the embodiment 1.

Now, a case of duplicating the video signal DD reproduced from the authorized CD-ROM 37 on a magnetic tape by the video tape recorder VTR will be discussed.

The DVD reproduction device 36 is not provided with a terminal for directly taking out the video signal DD, by specifying the video output terminal 40 with the internal wiring.

Therefore, only the video signal D CU, V, I, X) processed by the processing circuit 6 is sent to the video tape recorder VTR.

The PLL circuit of the external video tape recorder VTR not illustrated becomes disordered in the same manner as in the embodiment 1, and becomes inoperative. Accordingly, the increased quasi burst signal B2 is recorded on the magnetic tape, as a part of the video signal.

The reproduction of such recorded magnetic tape by the TV monitor 31 leads to giving influence to the color signal detection circuit, which in consequence reproduces a picture image with a color abnormally changed, in the same manner as in the embodiment 1. Here, the video tape recorder VTR may be incorporated into the DVD reproduction device 36.

The cases with the authorized magnetic tape 3 and the authorized CD-ROM 37 have been explained, however it is also conceivable to record the copy guard signal Q on a magneto-optical disk MO or a DVD-CD in advance, and to provide an MO reproduction device or a DVD reproduction device with the detection 39 for detecting the copy guard signal Q and the processing circuit 6.

With this configuration, to duplicate the video signal outputted therefrom on a magnetic tape will make it impossible to attain a record with a normal color, in the same manner as in the embodiment 2.

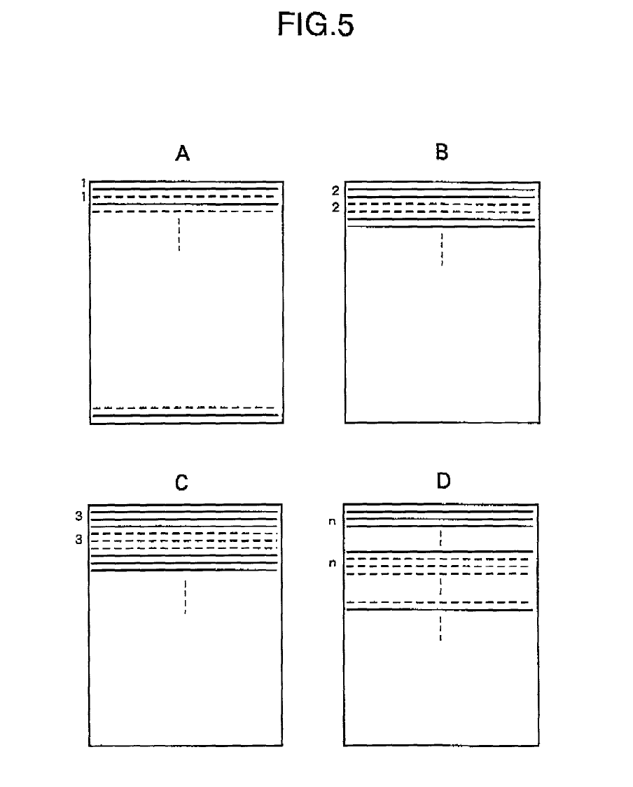

FIG. 5 typically illustrates a state that the number of the color burst signal B and the number of the quasi burst signal B1 in one frame vary according to the values set by the line number controller 26.

FIG. 5A illustrates the state that the color burst signal B and the quasi burst signal B1 appear alternately in one frame. FIG. 5B illustrates the state that the color burst signal B and the quasi burst signal B1 appear every two lines alternately in one frame. FIG. 5C illustrates the state that the color burst signal B and the quasi burst signal B1 appear every three lines alternately in one frame. FIG. 5D illustrates the state that the color burst signal B and the quasi burst signal B1 appear every n (n<250) lines alternately in one frame.

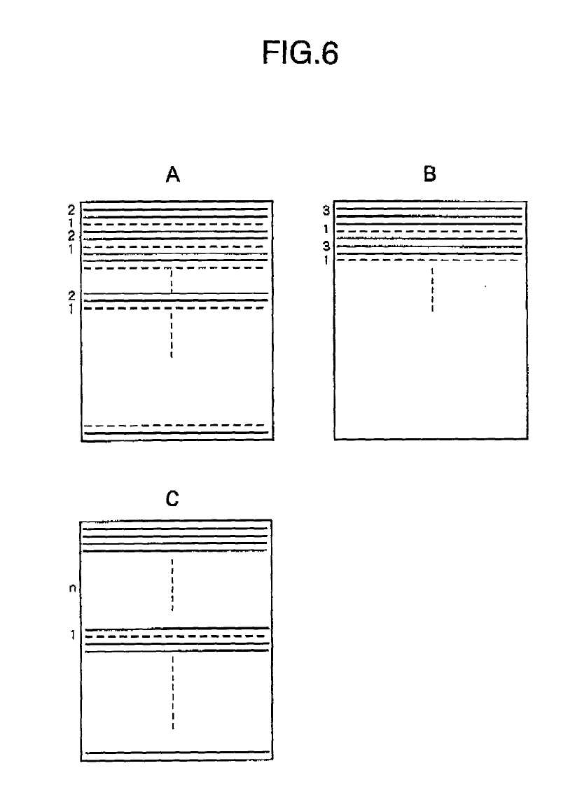

FIG. 6A illustrates the state that the color burst signal B appears by two lines and then the quasi burst signal B1 appears by one line, and repeats this phenomenon thereafter, in one frame. FIG. 6B illustrates the state that the color burst signal B appears by three lines and then the quasi burst signal B1 appears by one line, and repeats this phenomenon thereafter, in one frame. FIG. 6C illustrates the state that the color burst signal B appears by n (n<250) lies and then the quasi burst signal B1 appears by one line, and repeats this phenomenon thereafter, in one frame.

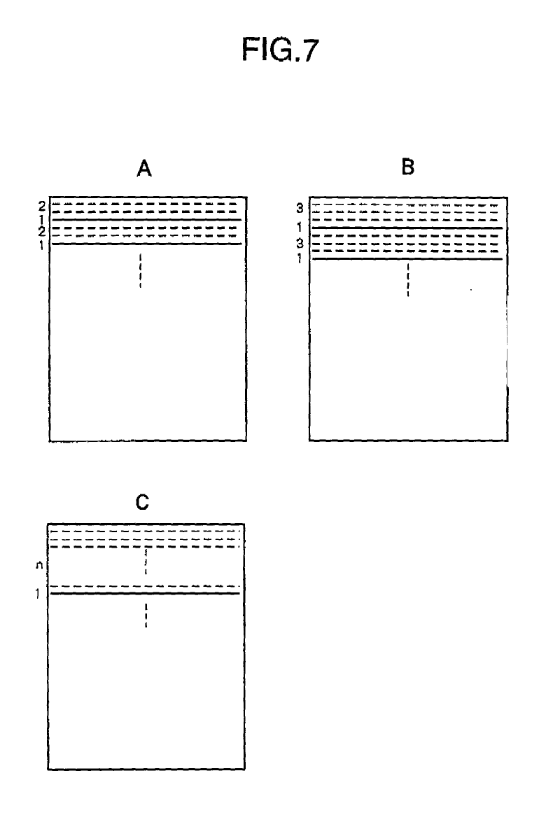

FIG. 7A illustrates the state that the quasi burst signal B1 appears by two lines and then the color burst signal B appears by one line, and repeats this phenomenon thereafter, in one frame. FIG. 7B illustrates the state that the quasi burst signal B1 appears by three lines and then the color burst signal B appears by one line, and repeats this phenomenon thereafter; in one frame. FIG. 7C illustrates the state that the quasi burst signal B1 appears by n (n<250) lines and then the color burst signal B appears by one line, and repeats this phenomenon thereafter, in one frame.

In the same manner, there are various types conceivable of the changing states of the wave number set by the wave number controller 21, and the combinations of the horizontal scanning line number set by the line number controller 26 and the wave number set by the wave number controller 21. And, it is possible to set the unique and optimum values among these combinations, by experimenting each VTR products available to find out which combination of these values is the most effective for protecting the magnetic tapes from an unfair duplication.

According to this invention, by adding a signal having the reverse phase and double the amplitude to the burst signal by several cycles of the burst signal, the color signal detection circuit of a video tape recorder receives influence by the quasi burst signal B1 to be brought into malfunction, thus preventing a normal recording.

Thereby, a reproduction of the magnetic tape duplicated by this video tape recorder on a TV monitor will present the picture image with the color abnormally changed.

On the other hand, the color signal detection circuit of the TV monitor does not receive influence to reproduce a normal color picture, thus preventing an unfair duplication to contribute to the copyright protection.

It should be apparent to those skilled in the art that the present invention may be embodied in many other specific forms without departing from the spirit or scope of the invention. Therefore, the present examples and embodiments are to be considered as illustrative and not restrictive and the invention is not to be limited to the details given herein, but may be modified within the scope and equivalence of the appended claims.

What is claimed is:

1. A method of recording a magnetic tape, comprising, during a period of a burst signal that controls a color in a video signal, adding a signal having the reverse phase and double the amplitude of the burst signal by less than some cycles of the burst signal to superpose on the burst signal, and recording a processed burst signal on the magnetic tape, wherein, when reproducing the magnetic tape, a color signal detection circuit of a TV monitor is not influenced to reproduce a normal picture image, and the color signal detection circuit of a video tape recorder is influenced to malfunction, preventing a correct recording, whereby to reproduce a magnetic tape being duplicated by the video tape recorder by the TV monitor presents an abnormal picture image.

2. A method of recording a magnetic tape, as claimed in claim 1, wherein the less than some cycles of the burst signal are any one of half the cycle (half the wave), one cycle (one wave), 1.5 cycles (1.5 waves), 2 cycles (2 waves), 2.5 cycles (2.5 waves), 3 cycles (3 waves), 3.5 cycles (3.5 waves), 4 cycles (4 waves), 4.5 cycles (4.5 waves), and 5 cycles (5 waves).

3. A method of recording a magnetic tape, as claimed in claim 1, wherein the starting position of the signal being added to the burst signal is the same as the starting position of the burst signal.

4. A method of recording a record medium, comprising, during a period of a burst signal that controls a color in a video signal, recording a command together with the video signal on the record medium, that adds a signal having the reverse phase and double the amplitude of the burst signal by less than some cycles of the burst signal to superpose on the burst signal, wherein, when reproducing the record medium, a color signal detection circuit of a TV monitor is not influenced to reproduce a normal picture image, and the color signal detection circuit of a video tape recorder is influenced to malfunction, preventing a correct recording, whereby a reproduction of a magnetic tape created by the video tape recorder duplicating a picture image recorded on the record medium by the TV monitor presents an abnormal picture image.

5. A record medium, whose picture image is reproduced on a TV monitor, on which, during a period of a burst signal that controls a color in a video signal, a command that adds a signal having the reverse phase and double the amplitude of the burst signal by less than some cycles of the burst signal to superpose on the burst signal is recorded together with the video signal.

6. A record medium as claimed in claim 5, wherein the record medium is a compact disk that uses an optical/electronic system.

7. A record medium as claimed in claim 5, wherein the record medium is a magneto-optical disk that uses an optical/magnetic/electronic system.

8. A recording device to record a video signal reproduced on a TV monitor on a record medium, which records, during a period of a burst signal that controls a color in the video signal, a command together with the video signal, that adds a signal having the reverse phase and double the amplitude of the burst signal by less than some cycles of the burst signal to superpose on the burst signal.
